(19) United States
(12) Patent Application Publication
(10) Pub. No.: US 2017/0229038 A1
(43) Pub. Date: Aug. 10, 2017

(54) MyFlexDiet Method

(71) Applicant: Mantian Zhu, Oakton, VA (US)

(72) Inventor: Mantian Zhu, Oakton, VA (US)

(21) Appl. No.: 15/019,410

(22) Filed: Feb. 9, 2016

(51) Int. Cl. G09B 19/00; G09B 5/00

(52) U.S. Cl. CPC G09B 19/0092; G09B 5/00

(57) ABSTRACT

The MyFlexDiet method allows an individual to consume freely food items for one meal of the day and provides a computer program that suggests the diet menu for exactly two other meals such that the total daily calorie intake meets the target; calorie intake outside of the three meals is prohibited.

### RELATED APPLICATIONS

U.S. Patent Documents

| | | |
|---|---|---|
| 4,951,197 | August, 1990 | Mellinger |
| 6,083,006 | July, 2000 | Coffman |
| 6,283,914 | September, 2001 | Mansfield |
| 6,356,940 | March, 2002 | Short |
| 7,413,438 | August, 2008 | Bisogno |
| 7,788,113 | August, 2010 | Fuhrman, Levill |
| 8,117,176 | February, 2012 | Lee |

### FEDERALLY SPONSORED RESEARCH

Not Applicable

### JOINT RESEARCH AGREEMENT

Not Applicable

### MATERIAL SUBMITTED ON A COMPACT DISC

Not Applicable

### BACKGROUND

Field of Invention

This invention relates to a dieting method for individuals with weight management concern. More particularly, the present invention relates to a method for providing individuals the flexibility to consume freely food items for one meal of the day and a computer program suggesting the diet menu for exactly two other meals such that the total daily calorie intake meets the target. The method prohibits any calorie intake outside of the three meals.

Description of Related Art

The present invention is a dieting method that offers both the flexibility and structure to help an individual manage his/her weight.

Various methods and systems exist to facilitate monitoring of nutrition content of food consumption. Existing methods and systems, however, typically calculate the nutritional values of the consumables and provide the results to the user; they lack the capability to interactively suggest a complete diet menu that satisfies the target daily calorie intake.

Other existing diet methods and systems typically provide a guideline or suggest a complete diet menu. They lack the flexibility for the user to consume freely food items for one meal of the day while still bound by the target daily calories intake and the prohibition of consuming food items outside of the three meals.

Due to the above identified shortcomings in the existing art, a flexible, structured, and interactive dieting method is needed for improving the user's probability of achieving weight management goals.

### SUMMARY OF INVENTION

The present invention is a dieting method that allows the user to consume freely food items for one meal of the day and provides a computer program, which suggests the diet menu for exactly two other meals such that the total daily calorie intake meets the target; the method prohibits calorie intake outside of the three meals.

The combination of flexibility and structure is identified as the key ingredient for the long term success of a dieting method and is the key advantage of the present invention. Flexibility is provided by allowing the user to consume freely food items for one meal of the day. Structure is provided by 1) the boundary of target daily calorie intake and 2) the prohibition of calorie intake outside of the three meals.

The combination of following three elements is the key advantage of the present invention to the existing art.
1. The flexibility to consume freely for one meal of the day
2. The interactive suggestion of the diet menu for the other two meals such that the total daily calorie intake meets the target
3. The prohibition of calories intake outside of the three meals

Other aspects and advantages of the present invention will become apparent from the following DETAILED DESCRIPTION OF THE INVENTION.

### DETAILED DESCRIPTION OF THE INVENTION

The present invention is a dieting method that combines the following three elements to help an individual manage his/her weight.
1. The flexibility for the user to choose any food items and the desired serving sizes for consumption for one meal of the day
2. The interactive computer program that suggests the diet menu for the other two meals such that the total daily calorie intake meets the target
3. The prohibition of calories intake outside of the three meals

The dieting method consists two steps:
1. The user chooses freely food items to consume for one meal of the day and enters the food items and their corresponding serving sizes in a computer program;
2. The computer program suggests the diet menu for exactly two other meals such that the total daily calorie intake meets or approximates a pre-defined target; the computer program prohibits any entry of food items outside of the three meals.

The main advantage of the present invention to the existing art is that it helps the user to adhere to a pre-defined target daily calorie intake without feeling deprived by allowing the user to consume food items freely for one meal of the day. The user has that one special meal to look forward to for the day; it makes it easier for the user to adhere to the structures of the method, 1) the boundary of the target daily calorie intake and 2) the prohibition of calorie intake outside of the three meals.

With the flexibility and the structure offered by the present invention, the user has a higher probability to achieve the weight management goal for the long term.

1) A dieting method, which allows an individual to consume freely food items for one meal of the day, and upon entry of the food items and their corresponding serving sizes of the meal into a computer program, it suggests the diet menu for exactly two other meals such that the total daily calorie intake meets or approximates a pre-defined target; the method prohibits calorie intake outside of the three meals. The dieting method consists two steps:
a. The user chooses freely food items to consume for one meal of the day and enters the food items and their corresponding serving sizes in a computer program;
b. The computer program suggests the diet menu for exactly two other meals such that the total daily calorie intake meets or approximates a pre-defined target;
the computer program prohibits any entry of food items outside of the three meals.

2) The method as claimed in claim 1, wherein the user may substitute food items and/or change the serving sizes in the computer program suggested meals within the boundary of the target daily calorie intake.
